(19) United States
(12) Patent Application Publication
(10) Pub. No.: US 2010/0127869 A1
(43) Pub. Date: May 27, 2010

(54) HIERARCHY OF RFID TAGS FOR ACCESSING HISTORY AND OTHER DATA

(75) Inventors: Gening (GARY) Yu, Farmington Hills, MI (US); Ramon F. Sarraga, Warren, MI (US); Shang-Tae Yee, Troy, MI (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., Detroit, MI (US)

(21) Appl. No.: 12/276,939

(22) Filed: Nov. 24, 2008

(51) Int. Cl. G08B 13/14

(52) U.S. Cl. 340/572.1

(57) ABSTRACT

A hierarchical configuration of RFID tags. The hierarchical configuration includes a plurality of RFID tags having lower level RFID tags, intermediate level RFID tags and at least one upper level RFID tags, where each RFID tag stores an identification code and other information about the thing it is attached to. Further, each intermediate level RFID tag also obtains information about a group of lower level RFID tags that it is associated with and the at least one upper level RFID tag obtains information about more than one intermediate RFID tag it is associated with.

### BACKGROUND OF THE INVENTION

1. Field of the Invention

This invention relates generally to a hierarchical configuration of RFID tags and, more particularly, to a hierarchical configuration of RFID tags where the RFID tags can be placed on products, containers that identify the products therein and delivery systems that transport the containers in a hierarchical manner so that reading an RFID tag at an upper level provides information about things at lower levels.

2. Discussion of the Related Art

Radio frequency identification (RFID) tags are well known in the art. RFID tags store an identification number or code, and other information, such as location produced, shelf life, etc, for a thing that the tag is attached to, such as a product, a container, a place, etc. An RFID tag includes an antenna and suitable processing circuitry for receiving an interrogation signal from an RFID reader. The RFID tag interrogates an RFID reader by transmitting and receiving RF signals. The RFID tag can be active or passive, where a passive tag does not include a power source, but employs inductive coupling where the interrogation signal from the reader generates the power necessary to transmit the RFID code. An active RFID tag includes a power source that provides the power to transmit the RFID code to the reader.

Current RFID tags are programmed with an identification code that identifies information about the particular thing that it is attached to. However, these RFID tags are not programmed to identify information about other things that may be associated with the thing that the RFID tag is attached to. For example, an RFID tag on a container may only identify information about the container, and not information about the contents of the container. It may be desirable to provide a hierarchical configuration of RFID tags where upper level RFID tags can obtain information about lower level things associated with that RFID tag.

### SUMMARY OF THE INVENTION

In accordance with the teachings of the present invention, a hierarchical configuration of RFID tags is disclosed. The hierarchical configuration includes a plurality of RFID tags having lower level RFID tags, intermediate level RFID tags and at least one upper level RFID tags, where each RFID tag stores an identification code and other information about the thing it is attached to. Further, each intermediate level RFID tag also obtains information about a group of lower level RFID tags that it is associated with and the at least one upper level RFID tag obtains information about more than one intermediate RFID tag it is associated with.

Additional features of the present invention will become apparent from the following description and appended claims, taken in conjunction with the accompanying drawings.

### BRIEF DESCRIPTION OF THE DRAWINGS

FIG. 1 is a block diagram of an RFID tag and associated RFID reader; and

FIG. 2 is a block diagram of a hierarchical configuration of RFID tags.

### DETAILED DESCRIPTION OF THE EMBODIMENTS

The following discussion of the embodiments of the invention directed to a hierarchical configuration of RFID tags is merely exemplary in nature, and is in no way intended to limit the invention or its applications or uses.

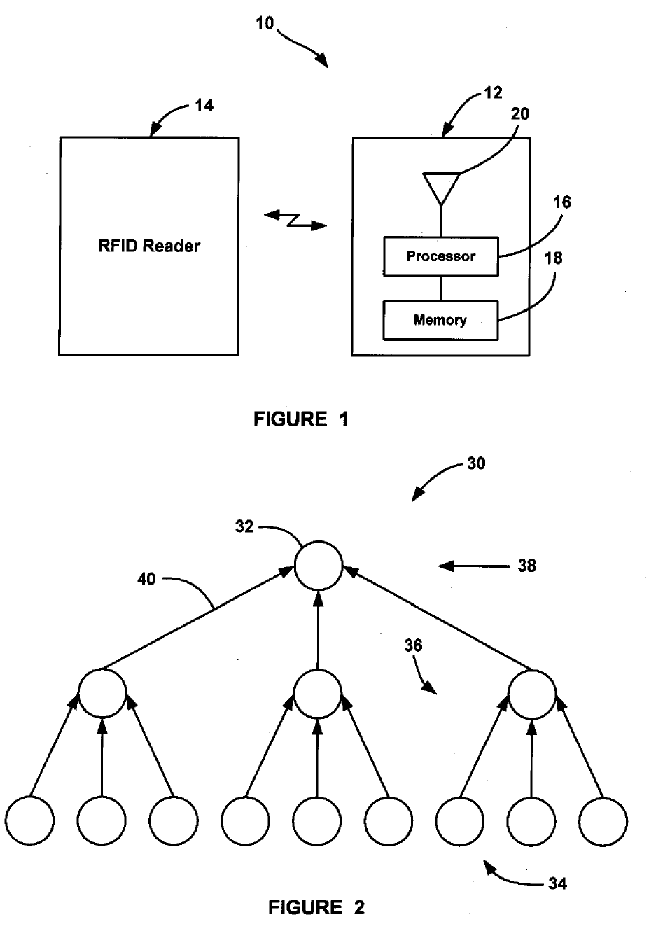

FIG. 1 is a block diagram of a system 10 showing an RFID tag 12 and an associated RFID reader 14. The RFID tag 12 includes a processor 16 that controls the operation of the RFID tag 12. The RFID tag 12 also includes an antenna 20 that receives interrogation signals from the reader 14 and transmits RFID signals including information that is stored in a memory 18 back to the reader 14. The information that is stored in the memory 18 can be any information suitable for a particular purpose, such as an identification code, a product code, a location code, manufacturing information, travel information, specifications, product history, etc. The size of the RFID tag 12 and the amount of processing circuitry therein would depend on the specific application it is being used for, where that application could be nearly limitless. The operation of RFID tags, whether passive or active, are well understood in the art and the frequencies that they operate at are also well understood.

FIG. 2 is a plan view of a hierarchical configuration 30 of RFID tags 32. The hierarchical configuration 30 of the RFID tags 32 is arranged in hierarchical layers, including a lower layer 34, an intermediate layer 36 and an upper layer 38. Arrows 40 in the configuration 30 show the direction of information flow from the lower levels to the upper levels of the configuration 30. The RFID tags 32 associated with the lower layer 34 may store information about a particular thing, such as a product. The RFID tags 32 in the intermediate layer 36 may store information about a group of the things in the lower layer 34. In this non-limiting example, each RFID tag 32 in the intermediate layer 36 stores information about three separate things identified by RFID tags 32 in the lower layer 34. Thus, someone reading an RFID tag 32 in the intermediate layer 36 can obtain information about the things having the RFID tags 32 in the lower layer 34. A single RFID tag 32 is associated with the upper level 38, and stores information about a plurality of the RFID tags 32 in the intermediate layer 36, here three. Thus, someone reading the RFID tag 32 at the upper level 38 can obtain information about things in the intermediate layer 36.

Although the above discussion is logical operational, the implementation may be different because RFID tags may not be able to directly talk to each other.

The lower level RFID tags 32 may be placed on specific products and the intermediate level RFID tags 32 may be placed on containers in which the specific products are stored. Further, the upper level RFID tag 32 may be placed on a truck, where the containers including the intermediate level RFID tags 32 are being transported. Thus, someone using the RFID reader 14 can read a single upper level RFID tag 32 to determine specific information about the truck itself and the containers on the truck, and can read an RFID tag 32 on a container on the truck to obtain information about the container and things stored within the container. Therefore, if somebody wants to know what items are in a particular container and what containers are on a particular truck, they only need to read one RFID tag to make that determination.

Although containers and trucks are used in this example, the hierarchical configuration 30 of RFID tags 32 is intended to be provided for any situation where RFID tags can identify certain things and upper level RFID tags can be used to identify groups of lower level RFID tags.

In another application, the hierarchical configuration 30 could use the RFID tags 32 for plant floor management and vehicle assembly operations.

If the arrangement of the RFID tags 32 changes, for example, where the containers identified by the intermediate level RFID tags 32 are put on a different truck having a different upper level RFID tag, the upper level RFID tag 32 can be programmed with information for the new RFID tags at the intermediate level 36.

Further, the RFID tags 32 can be programmed with their history to show where they have been. For example, if the containers have been moved from one truck to another truck, the intermediate level RFID tags 32 and the upper level RFID tag 32 can be programmed to include the information about where they came from. The upper level RFID tag 32 can store information about containers that have been removed from the truck and the intermediate level RFID tags can store information concerning previous trucks that the containers where on.

The hierarchical configuration 30 could be used, for example, to check whether a container is full or to check which parts may be missing in an assembly. The analysis of the history data can help derive the optimal solutions in packaging parts in a container, grouping containers in the shipment, etc.

The hierarchical configuration 30 offers greater potential flexibility. For example, the upper level 38 of the hierarchical configuration 30 could be implemented in software within an accessing device, such as a computer. In addition, lower level hierarchical RFID tags can be removed from the hierarchical configuration 30 and be inserted into another configuration. RFID tags of different vendors can be arranged as sub-trees above a larger tree, provided that the root nodes of the sub-trees adhere to the same present communication protocol with the higher level nodes of the larger tree.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A hierarchical configuration of RFID tags comprising a plurality of RFID tags including lower level RFID tags, intermediate level RFID tags and at least one upper level RFID tag, each RFID tag storing information identifying that RFID tag and a thing it is attached to, wherein each intermediate level RFID tag also stores information about a group of lower level RFID tags and things they are attached to that it is associated with and the at least one upper level RFID tag obtains information about more than one intermediate level RFID tag it is associated with, and wherein each of the intermediate level RFID tags and the at least one upper level RFID tags being interrogated to transmit its stored information.

2. The configuration according to claim 1 wherein the intermediate level RFID tags and the at least one upper level RFID tag store historical information that was previously associated with that RFID tag.

3. The configuration according to claim 1 wherein the lower level RFID tags are attached to products.

4. The configuration according to claim 3 wherein the intermediate level RFID tags are attached to containers where the products are stored in the containers.

5. The configuration according to claim 4 wherein the at least one upper level RFID tag is attached to a truck where the containers are on the truck.

6. The configuration according to claim 5 wherein the upper level RFID tag stores information about containers that have been removed from the truck.

7. The configuration according to claim 5 wherein the intermediate level RFID tags store information concerning previous trucks that the containers where on.

8. The configuration according to claim 1 wherein the hierarchical configuration of RFID tags is used for plant floor management and vehicle assembly operations.

9. The configuration according to claim 1 wherein the at least one upper level RFID tag is implemented in software.

10. A hierarchical configuration of RFID tags comprising a plurality of RFID tags at more than one hierarchical layer, wherein a plurality of the plurality of RFID tags obtains information about particular things at a lower level of the hierarchical configuration and at least one RFID tag of the plurality of RFID tags obtains information about a plurality of the things having RFID tags at the lower level.

11. The configuration according to claim 10 wherein the RFID tags store historical information that was previously associated with the RFID tag.

12. The configuration according to claim 10 wherein the lower level RFID tags are attached to products.

13. The configuration according to claim 12 wherein intermediate level RFID tags are attached to containers where the products are stored in the containers.

14. The configuration according to claim 13 wherein an upper level RFID tag is attached to a truck where the containers are on the truck.

15. The configuration according to claim 14 wherein the upper level RFID tag stores information about containers that have been removed from the truck.

16. The configuration according to claim 13 wherein the intermediate level RFID tags store information concerning previous trucks that the containers where on.

17. The configuration according to claim 10 wherein the hierarchical configuration of RFID tags is used for plant floor management and vehicle assembly operations.

18. The configuration according to claim 10 wherein the at least one upper level RFID tag is implemented in software.

19. A hierarchical configuration of RFID tags comprising a plurality of RFID tags at more than one hierarchical layer where upper level RFID tags store information about lower level RFID tags, said hierarchical configuration of RFID tags being used for plant floor management and vehicle assembly operations.

20. The configuration according to claim 19 wherein the RFID tags store historical information that was previously associated with the RFID tag.
